(19) United States
(12) Patent Application Publication
(10) Pub. No.: US 2025/0356546 A1
(43) Pub. Date: Nov. 20, 2025

(54) METHOD FOR SYNTHESIZING COMPUTERIZED ANGIOGRAPHY IMAGING BASED ON MULTI-SCALE DISCRIMINATION

(71) Applicant: THE FIRST MEDICAL CENTER OF PLA GENERAL HOSPITAL, Beijing (CN)

(72) Inventors: Xin LOU, Beijing (CN); Jinhao LYU, Beijing (CN); Mingliang YANG, Beijing (CN); Qi DUAN, Beijing (CN)

(73) Assignee: THE FIRST MEDICAL CENTER OF PLA GENERAL HOSPITAL, Beijing (CN)

(21) Appl. No.: 19/283,453

(22) Filed: Jul. 29, 2025

Related U.S. Application Data
(63) Continuation of application No. PCT/CN2023/109829, filed on Jul. 28, 2023.

(30) Foreign Application Priority Data
Jul. 29, 2022 (CN) 202210907807.8

(51) Int. Cl. G06T 11/00; G06V 10/32; G06V 10/44; G06V 10/75; G06V 10/774; G06V 10/776; G06V 10/82

(52) U.S. Cl. CPC G06T 11/005; G06V 10/32; G06V 10/454; G06V 10/75; G06V 10/774; G06V 10/776; G06V 10/82; G06T 2211/404; G06T 2211/441

(57) ABSTRACT

The present invention discloses a method for synthesizing computerized angiographic imaging based on multi-scale discrimination, which includes generating a normalized training dataset and a normalized validation dataset; constructing a generator and a multi-scale discriminator; training the generator and the multi-scale discriminator based on the normalized training dataset; normalizing the non-contrast CT image to be processed and inputting it into the trained generator G to output a normalized synthetic CTA image; and restoring the normalized synthetic CTA image to its original pixel value range to obtain the synthetic CTA image. The present invention employs a multi-scale discriminator to perform multi-scale discrimination on the output of the generator, enabling the synthesized CTA images to highlight the target images specified by the windowing operation parameters and designated regions, thereby enhancing the accuracy of discrimination.

### CROSS-REFERENCE TO RELATED APPLICATIONS

The application claims priority to Chinese patent application No. 202210907807.8, filed on Jul. 29, 2022, the entire contents of which are incorporated herein by reference.

### TECHNICAL FIELD

The present invention involves artificial intelligence technology, and more specifically, it is about a method for synthesizing computerized angiography imaging based on multi-scale discrimination.

### BACKGROUND

Iodine-based contrast agents are widely used for enhancing tissue contrast in CT angiography (CTA). However, these contrast agents are not suitable for subjects with iodine allergies, renal insufficiency, or multiple myeloma. Ideally, the contrast agent injected into the subject's body would be metabolized and excreted without causing any adverse effects. However, accidents caused by contrast agents do occur, such as bronchial spasms and anaphylactic shock, with severe cases even being life-threatening. Therefore, there is an urgent need for relevant technologies or methods to address the aforementioned issues.

In recent years, with the development of deep learning, computer vision deep learning models represented by the Pix2pix network [Isola P, et al. Proceedings of the IEEE Conference on Computer Vision and Pattern Recognition. 2017:1125-1134.] emerged, which has achieved the conversion between two types of images. However, this method is mainly designed for natural image conversion and has limited performance in medical image conversion tasks. To address these limitations, researchers have developed medical image modality conversion models represented by the MedGAN network [Armanious K, et al. Computerized Medical Imaging and Graphics, 2020, 79:101684]. In terms of the generator, MedGAN replaces the U-Net network in Pix2pix with CasNet. In terms of the discriminator, MedGAN employs a joint optimization of style loss, content loss, perceptual loss, and adversarial loss to further enhance the quality of the generated images. These methods have, to varying degrees, advanced the research in medical image modality conversion. However, due to the lack of consideration for windowing operations and regional differences in medical images, the synthetic models trained under these conditions fail to highlight important zones.

### SUMMARY

The present invention aims to propose a method for synthesizing computerized angiography imaging based on multi-scale discrimination, in response to the aforementioned issues in the current technology.

The objective of the present invention is achieved through the following technical means:

A method for synthesizing computerized angiography imaging based on multi-scale discrimination, including the following steps:
Step 1: Acquiring non-contrast CT images and real CTA images;
Step 2: Performing normalized processing on the registered non-contrast CT images and real CTA images. The normalized non-contrast CT images and the registered normalized real CTA images form a sample pair. A normalized training set and a normalized validation set are generalized, both of which include multiple sample pairs;
Step 3: Constructing a generator and a multi-scale discriminator;
Step 4: Training the generator and the multi-scale discriminator based on the normalized training set;

The normalized non-contrast CT image is input into the generator G, which outputs a normalized synthetic CTA image. The model parameters of generator G are optimized to minimize the value of the generator loss function.

The normalized synthetic CTA image and the corresponding normalized real CTA image are input into the multi-scale discriminator. The model parameters of the multi-scale discriminator are optimized to minimize the value of the multi-scale discriminator loss function.
Step 5: After normalizing the non-contrast CT image to be processed, input it into the trained generator G to generate a normalized synthetic CTA image. Then, restore the normalized synthetic CTA image to its original pixel range to obtain the synthetic CTA image;

In the aforementioned Step 3, the multi-scale discriminator comprises multiple discriminator groups corresponding to different windowing operations. Each discriminator group corresponding to the same windowing operation includes two sub-discriminators, one of which is a global discriminator and another is a local discriminator.

In the above-mentioned multi-scale discriminator:

Firstly, the normalized synthetic CTA image and the corresponding normalized real CTA image are subjected to windowing operations to obtain the normalized synthetic windowed CTA and the normalized real windowed CTA.

Then, the normalized synthetic windowed CTA and the normalized real windowed CTA obtained from each windowing operation are input into the corresponding discriminator group.

In the same discriminator group:

The normalized synthetic CTA windowed images and the normalized real CTA windowed images, both without going through center cropping, are input into the global discriminator for discrimination, respectively. The global discriminator outputs the pooling values corresponding to the normalized synthetic CTA windowed images and to the normalized real CTA windowed images, both without going through center cropping.

The normalized synthetic CTA windowed images and the normalized real CTA windowed images, both after going through center cropping, are input into the local discriminator for discrimination, respectively. The local discriminator outputs the pooling values corresponding to the normalized synthetic CTA windowed images and to the normalized real CTA windowed images, both after going through center cropping.

The above-mentioned generator includes an input layer, an encoder, a residual module, a decoder, and an output layer in sequence. The encoder comprises multiple-layer downsampling convolutional layers. The residual module includes several residual convolutional layers. The decoder consists of multiple-layer upsampling convolutional layers. Except for the output layer, the input layer, downsampling convolutional layers, residual convolutional layers, and upsampling convolutional layers all use instancenormal2d normalization and the ReLU activation function. The output layer performs a 2D convolution operation on the final upsampling result and outputs it through the tanh activation function.

As described above, both the global discriminator and the local discriminator include a downsampling convolutional layer and an output layer. The downsampling convolutional layers utilize the activation function LeakyReLU and InstanceNorm2d normalization. The output layer comprises a 2D convolutional layer and a pooling layer.

The windowing operation includes the following steps:

Firstly, restoring the pixel value range of the normalized non-contrast CT image and of the registered normalized real CTA image to the original pixel value range to obtain the restored non-contrast CT image and the restored real CTA image.

Then, performing windowing operations on the restored non-contrast CT image and the restored real CTA image based on the windowing operation parameters [window level, window width], and then normalizing them again to obtain the normalized non-contrast CT windowed image and the normalized real CTA windowed image.

Preferably, in the windowing operation, one of the windowing operations has a [window level, window width] of [(maximum original pixel value+minimum original pixel value+1)/2, (maximum original pixel value-minimum original pixel value+1)].

The generator loss function L_{G} is defined as:

$$min {L}_{G} = {\sum }_{i = 1}^{m} {a}_{i} * {L}_{GAN}^{i} ( G , {D}^{i} ) + {\sum }_{j = 1}^{n} {b}_{j} * {L}_{{L}_{1}}^{j} ( G )$$

$${L}_{GAN}^{i} ( G , {D}^{i} ) = E [ {( 1 - {D}^{i} ( A ) )}^{2} ]$$

$${L}_{{L}_{1}}^{j} ( G ) = E [ {‖ {y}^{j} - {G ( x )}^{j} ‖}_{1} ]$$

Where, Dⁱ is the i-th sub-discriminator, G is the generator, Dⁱ( ) is the output of i-th sub-discriminator, m is the total number of sub-discriminators, n is the total number of windowing operations, j is the index of the windowing operation, aᵢ is the weighted coefficient of the adversarial loss function

$${L}_{GAN}^{i} ( G , {D}^{i} )$$

corresponding to the i-th sub-discriminator, bⱼ is the weighted coefficient of the adversarial loss function

$${L}_{{L}_{1}}^{j} ( G )$$

under the j-th windowing operation; A is the normalized synthetic CTA windowed image without center cropping when the i-th sub-discriminator is a global discriminator; A is the normalized synthetic CTA windowed image after going through center cropping when the i-th sub-discriminator is a local discriminator; G(x)^{j} is the normalized synthetic CTA windowed image obtained from the j-th windowing operation; y^{j} is the normalized real CTA windowed image obtained by the j-th windowing operation, E is the expectation operator, ∥ ∥₁ is the distance operator L₁;

The multi-scale discriminator loss function includes the loss functions

$${L}_{adv}^{j} ( G , D )$$

of the discriminator groups corresponding to each windowing operation:

$$min {L}_{adv}^{j} ( G , D ) = {\sum }_{k = 1}^{K} ( E [ {( 1 - {D}_{k}^{j} ( B ) )}^{2} ] + E [ ( {{D}_{k}^{j} ( C )}^{2} ] )$$

Where, j is the index of windowing operation, k is the index of the sub-discriminator within the same discriminator group corresponding to the same windowing operation;

$${D}_{k}^{j} ( )$$

is the output of the k-th sub-discriminator in the j-th windowing operation; when the sub-discriminator corresponding to k is a global discriminator, B is the normalized real CTA windowed image without going through center cropping, and C is the normalized synthetic CTA windowed image without going through center cropping; when the sub-discriminator corresponding to k is a local discriminator, B is the normalized real CTA windowed image after going through center cropping, and C is the normalized synthetic CTA windowed image after going through center cropping.

Compared to the existing technology, the present invention has the following advantages:

The present invention utilizes a multi-scale discriminator to perform multi-scale discrimination on the output of the generator, enabling the synthesized CTA images to highlight the target images specified by the designated windowing operation parameters and designated regions, thereby enhancing the accuracy of discrimination;

The synthetic CTA images obtained by the present invention have the same pixel value range and data format as real CTA images, ensuring full compatibility with existing equipment;

The present invention utilizes the CTA to synthesize corresponding CT images, thereby reducing the necessity for the administration of iodine contrast agents.

### BRIEF DESCRIPTION OF DRAWINGS

FIG. 1 is a schematic diagram illustrating the implementation method of the present invention.

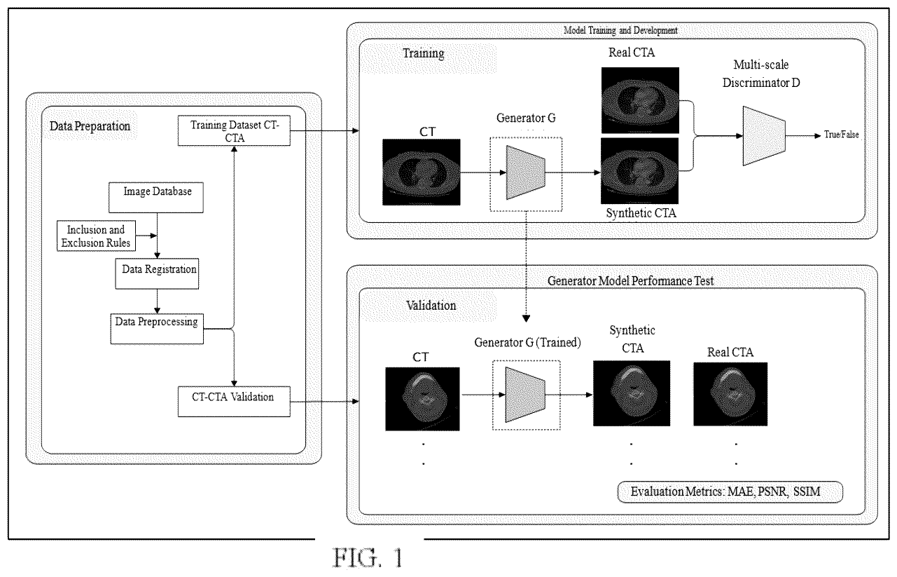

FIG. 2 is a schematic diagram illustrating the network architecture of the generator G in the present invention.

FIG. 3 is a schematic diagram illustrating the network architecture of the discriminator D in the present invention.

### DETAILED DESCRIPTION OF THE EMBODIMENTS

The terminology used in the Instructions is only to describe specific embodiments and is not exhaustive. Based on the implementation method described in this invention, all other implementation methods obtained by professionals in the field without making inventive contributions are within the scope of protection of this invention. Therefore, the detailed description of the implementation method of this invention provided in the figures is not intended to limit the scope of the invention claimed, but merely represents the selected implementation method of this invention.

The terms “including” and “having,” as well as their other variations, used in the Instructions, Claims, and the description of the Attached Figures, are intended to cover the stated items but are not limited to them.

To enable the technical personnel in this field to better understand the technical solution of the present invention, a detailed and complete description of the technical solution of the embodiments of the present invention is provided, regarding the attached figures of the embodiments.

### Embodiment 1

A method for synthesizing computerized angiographic imaging based on multi-scale discrimination, including the following steps:
Step 1: Data Acquisition: Establishing inclusion and exclusion rules according to the requirements to obtain non-contrast CT images and real CTA images. The inclusion and exclusion rules are as follows:

Inclusion Criteria: (1) Age is greater than 18 years old; (2) CT data includes both non-contrast CT images and real CTA images; (3) The slice thickness and number of slices of the non-contrast CT images and real CTA images are consistent, with each slice of the non-contrast CT images corresponding to each slice of the true CTA images; (4) The scanned parts are the neck, thorax, and abdomen; (5) The scanner model is a GE CT; (6) The initial slice thickness is 0.625 mm; (7) The contrast agent used is an iodine-based contrast agent.

Exclusion Criteria: (1) The non-contrast CT images or real CTA images contain severe artifacts, including beam-hardening artifacts caused by surgical metallic implants and motion artifacts; (2) The slice thickness and number of slices of the non-contrast CT images and real CTA images are inconsistent, or the slices of the non-contrast CT images do not correspond to the slices of the true CTA images; (3) Real CTA images that failed due to various reasons during the scanning; (4) Non-contrast CT images or real CTA images of arteries that have undergone surgical operations, such as post-aneurysm surgery.

Following the inclusion and exclusion rules, the CT-CTA data is collected through a database system. The specific operations include:

According to the inclusion and exclusion rules, the CT-CTA data are initially screened based on the inclusion criteria through the database system to obtain the non-contrast CT images and real CTA images after initial screening.

Conduct a manual inspection of the non-contrast CT images and real CTA images that have been initially screened from the database system, and eliminate those that meet the exclusion criteria.
Step 2: Registering and normalizing the non-contrast CT images and real CTA images obtained in Step 1. Specifically, normalizing the original pixel value range of the non-contrast CT images and real CTA images obtained in Step 1 from [−1024, 3071] to [−1, 1]. The normalized non-contrast CT images and the corresponding registered and normalized real CTA images form a sample pair. Using these sample pairs to construct a normalized training dataset and a normalized validation dataset. The data preprocessing operation includes the following steps:

Data registration: In this embodiment, the SyN registration algorithm of ANTs is utilized. The non-contrast CT image is used as the fixed space, and the real CTA image is used as the moving space. The non-contrast CT image and the real CTA image are registered accordingly.

Conducting a quality check on the data after registration, and eliminating the non-contrast CT images and real CTA images with failed registration.

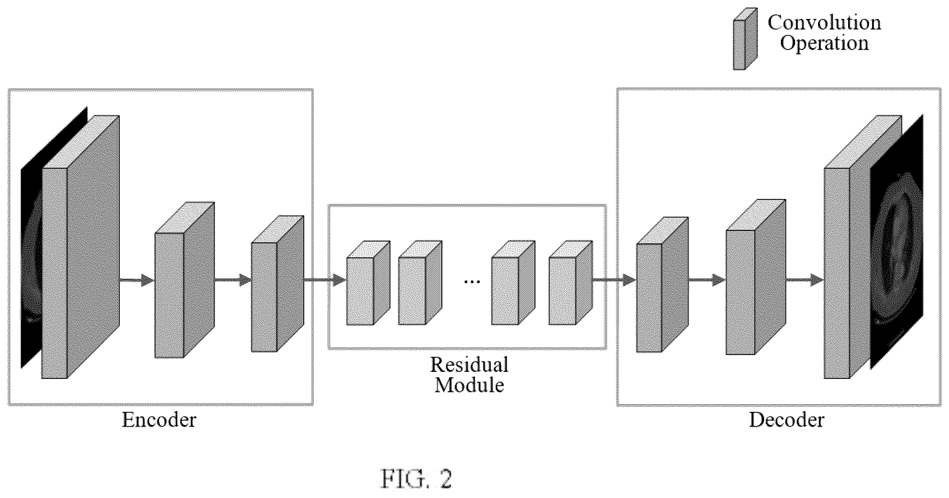

Normalizing the registered non-contrast CT images and real CTA images that have passed the quality check, respectively. The normalized non-contrast CT images and the registered normalized non-contrast CTA images form sample pairs, which are used to obtain the normalized training dataset and the normalized validation dataset. Both the normalized training dataset and the normalized validation dataset consist of multiple sample pairs.
Step 3: Constructing a generator and a multi-scale discriminator based on a multi-scale discrimination generative adversarial network (GAN).
Step 3.1: Constructing a generator. The framework of the generator in this embodiment is shown in FIG. 2. The generator sequentially includes an input layer, an encoder, residual modules, a decoder, and an output layer, and the basic network of the generator is CNN (Convolutional Neural Network). The normalized non-contrast CT image is input into the generator, and the generator outputs a normalized synthetic CTA image.

Furthermore, the encoder comprises two layers of downsampling convolutional layers, the residual module includes nine residual convolutional layers, and the decoder consists of two layers of upsampling convolutional layer.

The encoder has channel numbers of 1->64->128->256, the residual module has 256 channels, and the decoder has channel numbers of 256->128->64->1. The convolutional kernels of the input layer and output layer of the generator are 7×7, while the convolutional kernels of the convolutional layers in the encoder, residual module, and decoder are all 3×3. Except for the output layer, the input layer, downsampling convolutional layer, residual convolutional layer, and upsampling convolutional layer all utilize the InstanceNorm2d normalization and the activation function ReLU. The output layer performs a 2D convolution operation on the final upsampled result and outputs the normalized synthetic CTA image through the tanh activation function.

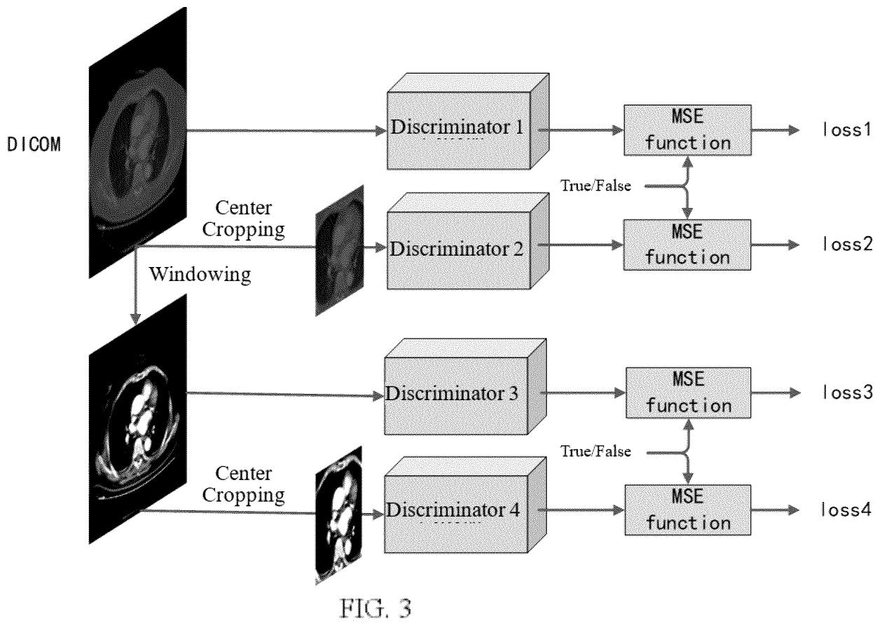

The dimensions of both the input layer and the output layer are Number of Batches×Number of Channels×Image Width×Image Height. In this embodiment, the number of batches is 1, the number of channels is 1, the image width is 512, and the image height is 512.
Step 3.2: Constructing a multi-scale discriminator. The framework of the discriminator model adopted in this embodiment is shown in FIG. 3. The multi-scale discriminator includes multiple discriminator groups corresponding to different windowing operations (in this embodiment, 2 discriminator groups corresponding to different windowing conditions are adopted). Each discriminator group corresponding to the same windowing operation includes two sub-discriminators, one of which is a global discriminator and another is a local discriminator.

Furthermore, the global discriminator in each discriminator group discriminates between the normalized synthetic CTA windowed images and the normalized real CTA windowed images, both without center cropping, and outputs the pooling values corresponding to the normalized synthetic CTA windowed images and the normalized real CTA windowed images without going through center cropping. The local discriminator in the same discriminator group discriminates between the center-cropped normalized synthetic CTA windowed images and the center-cropped normalized real CTA windowed images, and outputs the pooling values corresponding to the center-cropped normalized synthetic CTA windowed images and the center-cropped normalized true CTA windowed images.

The global discriminator and the local discriminator have the same network structure, each comprising four layers of downsampling convolutional layers and output layers. Each downsampling convolutional layer employs the LeakyReLU activation function and the InstanceNorm2d normalization, and conducts the output through an output layer consisting of a 2D convolutional layer and a pooling layer. Both the global and local discriminators use a 4×4 convolutional kernel for their downsampling convolutional layers and the 2D convolution in the output layer. The 2D convolutional layers in the output layers of the global and local discriminators, respectively, output 62×62 global matrix blocks and 30×30 local matrix blocks. These matrix blocks are then processed through the ‘avg_pool2d’ function of the PyTorch library (pooling layer) for average pooling to obtain the corresponding pooling value.

Calculating the loss values for the global and local discriminators. The discriminator groups under different windowing operations update their model parameters iteratively based on the weighted loss values of the global and local discriminators for each windowing condition.
Step 4: Training the generator and the multi-scale discriminator based on the normalized training dataset.

Inputting the normalized non-contrast CT images and the registered normalized real CTA images into the generator G of the multi-scale discriminative generative adversarial network. Using the normalized non-contrast CT images as the input to the generator G, which outputs the normalized synthetic CTA images. Calculating the generator loss function and optimizing the generator parameters based on the generator loss function value to minimize the generator loss function value.

Inputting the normalized synthetic CTA images and the corresponding normalized real CTA images into the multi-scale discriminator. In the multi-scale discriminator:

Firstly, the normalized synthetic CTA images and the corresponding normalized true CTA images are subjected to windowing operations to obtain normalized synthetic CTA windowed images and normalized real CTA windowed images.

Then, the normalized synthetic CTA windowed images and the normalized true CTA windowed images resulting from each windowing operation are input into the corresponding discriminator group.

In the discriminator group:

Inputting the normalized synthetic CTA windowed images and the normalized real CTA windowed images without center cropping into the global discriminator of the discriminator group for discrimination, and outputting the pooling values corresponding to the normalized synthetic CTA windowed images and the normalized true CTA windowed images without center cropping.

Inputting the center-cropped normalized synthetic CTA windowed images and the center-cropped normalized real CTA windowed images into the local discriminator of the same discriminator group for discrimination, and outputting the pooling values corresponding to the center-cropped normalized synthetic CTA windowed images and the center-cropped normalized true CTA windowed images.

The windowing operations include the following steps:

Firstly, restoring the pixel value range of the normalized non-contrast CT images and the registered normalized real CTA images to their original pixel value range to obtain the restored non-contrast CT images and the restored real CTA images.

Then, performing windowing operations on the restored non-contrast CT images and the restored real CTA images based on the windowing parameters [window level, window width], and then normalizing the results to obtain the normalized non-contrast CT windowed images and the normalized real CTA windowed images.

Preferably, one of the windowing operations uses the parameters [window level, window width]=[(max original pixel value)+(min original pixel value+1)/2, (max original pixel value−min original pixel value+1)]. In this embodiment, this means extracting the entire original pixel value range, which is [1024, 4096], where 1024=(−1024+3071+1)/2, and 4096=3071−(−1024)+1.

In this embodiment, the parameter [window level, window width] for another windowing operation is [40, 400].

Calculating the loss function

$${L}_{adv}^{j} ( G , D )$$

corresponding to the different windowing operations for the discriminator groups. Each discriminator group updates its parameters based on the loss function value of its corresponding discriminator group.

The generator and the multi-scale discriminator of the generative adversarial network are optimized in a coordinated manner to achieve the optimization and update of the global network parameters.

The generator loss function L_{G} is defined as:

$$min {L}_{G} = {\sum }_{i = 1}^{m} {a}_{i} * {L}_{GAN}^{i} ( G , {D}^{i} ) + {\sum }_{j = 1}^{n} {b}_{j} * {L}_{{L}_{1}}^{j} ( G ) \qquad ( 1 )$$

Where, Dⁱ is the i-th sub-discriminator, G is the generator, the number of sub-discriminators m is 4, the total number of windowing operations n is 2, and j is the index of the windowing operation. aᵢ is the weighted coefficient corresponding to the adversarial loss function

$${L}_{GAN}^{i} ( G , {D}^{i} )$$

of the i-th sub-discriminator, with values taken as 0.9, 0.1, 0.09, and 0.01, respectively. bⱼ is the weighted coefficient of the target loss function

$${L}_{{L}_{1}}^{j} ( G )$$

under the j-th windowing operation, with values taken as 20 and 5, respectively.

The adversarial loss function

$${L}_{GAN}^{i} ( G , D )$$

and the target loss function

$${L}_{{L}_{1}}^{j} ( G )$$

mentioned in Formula (1) are defined as follows:

$${L}_{GAN}^{i} ( G , {D}^{i} ) = E [ {( 1 - {D}^{i} ( A ) )}^{2} ] \qquad ( 2 )$$

$${L}_{{L}_{1}}^{j} ( G ) = E [ {‖ {y}^{j} - {G ( x )}^{j} ‖}_{1} ] \qquad ( 3 )$$

Dⁱ( ) is the output of the i-th sub-discriminator.

When the i-th sub-discriminator is a global discriminator, A is the normalized synthetic CTA windowed image without center cropping; when the i-th sub-discriminator is a local discriminator, A is the normalized synthetic CTA windowed image after going through center cropping.

G(x)^{j} is the normalized synthetic CTA windowed image obtained through the j-th windowing operation, and y^{j} is the normalized real CTA windowed image obtained through the j-th windowing operation.

E represents the expectation operator, and ∥ ∥1 represents the distance operator L₁.

The loss function

$${L}_{adv}^{j} ( G , D )$$

for the discriminator group corresponding to the j-th windowing operation is defined as:

$$min {L}_{adv}^{j} ( G , D ) = {\sum }_{k = 1}^{K} ( E [ {( 1 - {D}_{k}^{j} ( B ) )}^{2} ] + E [ ( {{D}_{k}^{j} ( C )}^{2} ] ) \qquad ( 4 )$$

Where, j takes values of 1 and 2, representing the indexes of two different windowing operations. The sub-discriminators for the same windowing operation include a global discriminator and a local discriminator. k is the index of the sub-discriminator for the same windowing operation, with corresponding subscripts taking values of 1 and 2. K is 2; when k takes the value 1, it corresponds to the global discriminator, and when k takes the value 2, it corresponds to the local discriminator.

$${D}_{k}^{j} ( )$$

is the output or the k-th sub-discriminator in the discriminator group corresponding to the j-th windowing operation. When k takes the value 1, B is the normalized real CTA windowed image without center cropping, and C is the normalized synthetic CTA windowed image without center cropping. When k takes the value 2, B is the normalized real CTA windowed image after going through center cropping, and C is the normalized synthetic CTA windowed image after going through center cropping. The discriminator groups under the two windowing operations optimize and update their parameters based on their respective loss function values.
Step 5: Normalizing the non-contrast CT image to be processed, and input it into the trained generator G to output the normalized synthetic CTA image. Then, restoring the normalized synthetic CTA image to its original pixel value range to obtain the synthetic CTA image.

The experimental platform in this embodiment is a Linux system server equipped with an NVIDIA Geforce RTX 3090Ti GPU and 64 GB of memory, running Python version 3.8.

The models of the generator and discriminator are constructed using PyTorch as the deep learning framework. The model training employs a single cross-loop iteration optimization of the generator and discriminator, which means that when the generator is optimized, the discriminator's model parameters remain fixed, and when the discriminator is optimized, the generator's model parameters remain fixed. The number of loop iterations epoch=60, with an initial learning rate of 0.0001 for both the generator and discriminator, and no decay strategy is applied.

During the training, the intermediate generator G obtained from each iteration is saved, and the performance metrics of all intermediate generators G are tested using the validation dataset.

Comparing the test performance metrics of all intermediate generators G, and selecting the intermediate generator G with the optimal test performance metrics as the final generator G.

The performance test metrics include Mean Absolute Error (MAE), Peak Signal-to-Noise Ratio (PSNR), and Structural Similarity Index (SSIM).

During use, the trained generator is loaded, and the normalized CT image is input into the trained generator, which then outputs the normalized synthetic CTA image.

According to the data preprocessing rules, the normalized synthetic CTA image in the range [−1, 1] is inversely normalized to reconstruct it to the original pixel value range [−1024, 3071], thereby obtaining the synthetic CTA image.

The synthetic CTA image reconstructed to the original pixel value range is converted to binary format and assigned to the PixelData field in the DICOM header file. The other DICOM header files remain consistent with the header files of the CT image data, thereby obtaining the synthetic CTA image data.

In this embodiment, the scanned parts selected are the neck, thorax, and abdomen. In practical applications, different generators can be trained for different regions according to specific needs, thereby enhancing the precision of CTA synthesis.

The present invention establishes a mapping relationship between CT and CTA through a trained generative adversarial network (GAN) model. During the usage phase, only the trained and saved generator needs to be loaded. The present invention focuses on using the GAN generator to construct the mapping relationship between CT and CTA, with the multi-scale discriminator used to evaluate the generated CTA images under different windowing operations and different fields of view. Other, more optimal, or similar generators can be substituted for the GAN generator as needed.

### Embodiment 2

Steps 1 to 5 described above are implemented through Modules 1 to 5 of a device for synthesizing computerized angiographic imaging based on multi-scale discrimination.

The present invention is not limited to the above-mentioned application. Within the knowledge scope of an ordinary person skilled in this field, without departing from the purpose of the present invention, it can be applied to other related fields.

It should be noted that the specific embodiments described in this invention are merely illustrative of the purpose of the present invention. Technicians in the domain to which the present invention pertains may make various modifications or supplements to the described specific embodiments or adopt similar alternatives without departing from the purpose of the present invention or exceeding the scope defined by the appended claims.

What is claimed is:

1. A method for synthesizing computerized angiography imaging based on multi-scale discrimination, characterized in that it includes the following steps:
Step 1: Acquiring non-contrast CT images and real CTA images;
Step 2: Performing normalization processing on the registered non-contrast CT images and real CTA images; The normalized non-contrast CT images and the registered normalized real CTA images form a sample pair. Generating a normalized training set and a normalized validation set, both of which include multiple sample pairs;
Step 3: Constructing a generator and a multi-scale discriminator;
Step 4: Training the generator and the multi-scale discriminator based on the normalized training set;
Firstly, the normalized non-contrast CT images are input into the generator G, which produces a normalized synthetic CTA image; The model parameters of the generator G are optimized to minimize the value of the generator loss function;
Secondly, the normalized synthetic CTA images and the corresponding normalized real CTA images are input into the multi-scale discriminator; The model parameters of the multi-scale discriminator are optimized to minimize the value of the multi-scale discriminator loss function;
Step 5: The non-contrast CT images to be processed are normalized and then input into the trained generator G to produce normalized synthetic CTA images; The normalized synthetic CTA images are subsequently rescaled to their original pixel range to obtain the synthetic CTA images;
In Step 3, the multi-scale discriminator comprises multiple discriminator groups corresponding to different windowing operations; Each discriminator group corresponding to the same windowing operation includes two sub-discriminators, one of which is a global discriminator and another is a local discriminator;
In the above-mentioned multi-scale discriminators:
Firstly, the normalized synthetic CTA image and the corresponding normalized real CTA image are subjected to windowing operations to obtain the normalized synthetic windowed CTA and the normalized real windowed CTA;
Then, the normalized synthetic windowed CTA and the normalized real windowed CTA obtained from each windowing operation are input into the corresponding discriminator group;
In the same discriminator group:
The normalized synthetic CTA windowed images and the normalized real CTA windowed images, both without going through center cropping, are input into the global discriminator for discrimination respectively; The global discriminator outputs the pooling values corresponding to the normalized synthetic CTA windowed images and to the normalized real CTA windowed images, both without going through center cropping;
The normalized synthetic CTA windowed images and the normalized real CTA windowed images, both having gone through center cropping, are input into the local discriminator for discrimination respectively; The local discriminator outputs the pooling values corresponding to the normalized synthetic CTA windowed images and the normalized real CTA windowed images, both having gone through center cropping;
The above-mentioned generator sequentially includes an input layer, an encoder, a residual module, a decoder, and an output layer; The encoder comprises multiple-layer downsampling convolutional layers; The residual module includes several residual convolutional layers; The decoder consists of multiple-layer upsampling convolutional layers; Except for the output layer, the input layer, downsampling convolutional layers, residual convolutional layers, and upsampling convolutional layers all use InstanceNorm2d normalization and the activation function ReLU; The output layer performs a 2D convolution operation on the final upsampling result and outputs it through the tanh activation function;
Both global discriminator and local discriminator include downsampling convolutional layers and output layers; The downsampling convolutional layers utilize the LeakyReLU activation function and InstanceNorm2d normalization; The output layer includes a 2D convolutional layer and a pooling layer;
The windowing operation includes the following steps:
Firstly, the pixel value range of the normalized non-contrast CT image and the registered normalized real CTA image is restored to the original pixel value range to obtain the restored non-contrast CT image and the restored real CTA image;
Then, the restored non-contrast CT image and the restored real CTA image are subjected to windowing operations based on the windowing parameters [window level, window width], and then normalized again to obtain the normalized non-contrast CT windowed image and the normalized real CTA windowed image;
In the windowing operation, one of the windowing operations has a [window level, window width] of [(maximum original pixel value+minimum original pixel value+1)/2, (maximum original pixel value-minimum original pixel value+1)];
The generator loss function L_{G} is defined as:
$$min {L}_{G} = {\sum }_{i = 1}^{m} {a}_{i} * {L}_{GAN}^{i} ( G , {D}^{i} ) + {\sum }_{j = 1}^{n} {b}_{j} * {L}_{{L}_{1}}^{j} ( G )$$
$${L}_{GAN}^{i} ( G , {D}^{i} ) = E [ {( 1 - {D}^{i} ( A ) )}^{2} ]$$
$${L}_{{L}_{1}}^{j} ( G ) = E [ {‖ {y}^{j} - {G ( x )}^{j} ‖}_{1} ]$$
Where, Dⁱ is the i-th sub-discriminator, G is the generator, Dⁱ( ) is the output of i-th sub-discriminator, m is the total number of sub-discriminators, n is the total number of windowing operations, j is the index of the windowing operation, aᵢ is the weighted coefficient of the adversarial loss function
$${L}_{GAN}^{i} ( G , {D}^{i} )$$
corresponding to the i-th sub-discriminator, bⱼ is the weighted coefficient of the objective loss function
$${L}_{{L}_{1}}^{j} ( G )$$
under the j-th windowing operation; A is the normalized synthetic CTA windowed image without going through center cropping when the i-th sub-discriminator is a global discriminator; A is the normalized synthetic CTA windowed image after going through center cropping when the i-th sub-discriminator is a local discriminator; G(x)^{j} is the normalized synthetic CTA windowed image obtained from the j-th windowing operation; y^{j} is the normalized real CTA windowed image obtained by the j-th windowing operation, E is the expectation operator, ∥ ∥₁ is the distance operator of L₁;
The multi-scale discriminator loss function includes the loss functions
$${L}_{adv}^{j} ( G , D )$$
of the discriminator groups corresponding to each windowing operation:
$$min {L}_{adv}^{j} ( G , D ) = {\sum }_{k = 1}^{K} ( E [ {( 1 - {D}_{k}^{j} ( B ) )}^{2} ] + E [ ( {{D}_{k}^{j} ( C )}^{2} ] )$$
Where, j is the index of windowing operation, k is the index of the sub-discriminator within the same discriminator group corresponding to the same windowing operation;
$${D}_{k}^{j} ( )$$
is the output of the k-th sub-discriminator in the j-th windowing operation; when the sub-discriminator corresponding to k is a global discriminator, B is the normalized real CTA windowed image without going through center cropping, and C is the normalized synthetic CTA windowed image without going through center cropping; when the sub-discriminator corresponding to k is a local discriminator, B is the normalized real CTA windowed image after going through center cropping, and C is the normalized synthetic CTA windowed image after going through center cropping.
